(19) United States
(12) Patent Application Publication
(10) Pub. No.: US 2019/0172354 A1
(43) Pub. Date: Jun. 6, 2019

(54) Device for Warning a Two-Wheeler Driver of a Collision with Another Vehicle

(71) Applicant: Hochschule für Technik und Wirtschaft des Saarland, Saarbruecken (DE)

(72) Inventors: Joerg Hoffmann, Namborn (DE); Michael Kirjanov, Saarbruecken (DE); Benjamin Lang, Saarlouisv (DE)

(21) Appl. No.: 15/995,262

(22) Filed: Jun. 1, 2018

(30) Foreign Application Priority Data
Dec. 5, 2017 (DE) DE 20 2017 107 39

(51) Int. Cl. G08G 1/16; B62J 3/00; B62J 99/00; B62J 6/00; B60W 30/09

(52) U.S. Cl. CPC G08G 1/166; B62J 3/00; B62J 99/00; B62J 6/00; G02B 13/06; B62J 2099/002; B60W 2550/20; B60W 2710/207; B60W 30/09

(57) ABSTRACT

Warning a two-wheeled vehicle driver, in particular a motorcyclist or cyclist, of a collision with a vehicle approaching the two-wheeled vehicle from a rearward space, is accomplished using a sensor device for capturing objects in the rearward space. In one embodiment, one of the sensors is provided for capturing objects in a close rearward range, which, in particular for the two-wheeled vehicle driver, is in the blind sport, and a further one of the sensors is arranged for capturing objects in a far rearward range, which in particular extends up to 50 m away from the two-wheeled vehicle.

The invention relates to an apparatus for warning a two-wheeled vehicle driver, in particular a motorcyclist or cyclist, of a collision with a vehicle approaching the two-wheeled vehicle from a rearward space, comprising a sensor device for capturing objects in the rearward space.

Lane change assistants are known from the state of the art. Sensors fixedly attached to a motorcycle observe an area not observable for a driver with a rearview mirror (“blind spot”). If, upon initiating a lane change, another vehicle is present in the blind spot, an optical or haptic warning signal is issued, signalizing the driver a risk of collision. It is disadvantageous, however, that a rearward space is not sufficiently monitored, so that a warning of fast approaching vehicles cannot be issued in time. While driving on a motorway, for example, this poses a high accident risk.

Furthermore, lane change assistants for motorcycles known from the state of the art in particular fail when taking bends. A vertical viewing angle of known sensors is maximum 60 degrees. When taking a bend, with an inclination of the motorcycle towards a road surface by the so-called roll angle, a blind range of the sensor is enlarged, so that no sufficient capturing of vehicles approaching in the blind spot may take place. Therefore, reliable collision warning is not possible.

Therefore, the present invention is based on the object to create an apparatus of the type initially stated, which enables a more reliable collision warning, in particular upon changing lanes.

According to the invention, the object is achieved by the sensor device having at least two sensors arranged for capturing objects in different areas of the rearward space.

For that, objects to be captured are detected by sensors particularly suited for capturing them in the respective area of the rearward space. Advantageously, missing or faulty capturing of objects, which results in a faulty or missed warning of the driver, is avoided.

Expediently, at least two structurally identical sensors or sensors different from one another are provided, which are in particular arranged for capturing road markings, lane boundaries and/or a vehicle approaching the two-wheeled vehicle. The sensors may be formed as radar, lidar or ultrasonic sensors, laser scanners and/or cameras, preferably digital cameras.

In one embodiment, one of the sensors is provided for capturing objects in a close rearward range, which, in particular for the two-wheeled vehicle driver, is in the blind sport, and a further one of the sensors is arranged for capturing objects in a far rearward range, which in particular extends up to 50 m away from the two-wheeled vehicle. Thus, advantageously, far-away objects as well as very close objects may be captured. A capturing range of up to 50 m behind the two-wheeled vehicle has proven to be advantageous, since thus, in particular on motorways, fast-driving vehicles approaching from the rear can be detected sufficiently early.

In a further embodiment of the invention, at least one of the sensors, preferably two of the sensors, is/are formed as a digital camera, and a first sensor is preferably formed as a mono-camera and a second sensor preferably as a camera with a wide-angle lens and/or fisheye lens, wherein the mono-camera further has a horizontal and/or vertical field of view of at least 90 degrees, preferably 110 degrees, and the camera with the wide-angle and/or fisheye lens has a horizontal and/or vertical field of view of at least 170 degrees, preferably 190 degrees. Advantageously, with cameras, images can be captured continuously, which may be digitally processed and from which information may be obtained using known methods of digital image processing.

In one embodiment of the invention, the mono-camera is provided for capturing objects in the far rearward range, in particular up to a depth of at least 30 m, preferably at least 40 m, particularly preferred 50 m, behind the two-wheeled vehicle, and the camera with the wide-angle and/or fisheye lens is arranged for capturing objects in the close rearward range.

Advantageously, the camera with a fisheye and/or wide-angle lens is able to capture a range, which the two-wheeled vehicle driver cannot see with auxiliary means like a rearview mirror (“blind spot”), while the mono-camera is particularly suited for a broad view of a rear space behind the two-wheeled vehicle. The combination of these two cameras has in particular proven to be advantageous for monitoring the rear space behind a two-wheeled vehicle, since no other combination of sensors permits comparably comprehensive monitoring of the rear space. Even when taking a bend, when the two-wheeled vehicle is driven inclined by the so-called roll angle, this combination enables sufficiently reliable monitoring of the rear space and has no blind areas, which the sensors cannot capture. Furthermore, these two cameras enable a very compact design of the apparatus, so that already existing two-wheeled vehicles may also be retrofitted without any problem.

Expediently, at least one inertial measurement unit, in particular a rotation rate sensor, is provided, which, preferably continuously, determines a roll angle and/or a pitch angle of the two-wheeled vehicle.

Advantageously, each sensor signal, in particular each image captured by a digital camera, can be allocated a roll angle and/or pitch angle determined at the point in time of the capture. This information is necessary for analysis of the sensor signals.

In one embodiment of the invention, an image processing unit is arranged for creating a single image from two images of the cameras taken at a same point in time by determining an overlap area, or for creating an image of the close range as well as an image of the far range from two images of the cameras taken at a same point in time, wherein an overlap area is allocated to the image of the far range. The overlap area is the area captured by each camera and visible in each of the images. In order to avoid double processing upon object detection, which significantly increases a computing effort, the overlap area only has to be checked once.

In a further embodiment of the invention, a unit for processing sensor signals is provided, which is in particular arranged for real-time processing of digital images, wherein, in upper and lower portions of images of the rearward space, objects, in particular road markings, lane boundaries and/or vehicles behind the two-wheeled vehicle, are detected above and below a horizon line, and a transformation of the processed image is undertaken using homography on a depiction showing an orthogonal top view of a rearward road section. Processing of images is preferably undertaken digitally. For detecting vehicles or road markings, so-called hair-like features, known from face recognition algorithms, may be applied. Nomography is a method known from digital image processing, wherein an image is transformed from one view into another view. In order to reduce computing time for the transformation of the image using homography, it is conceivable to blacken all image areas in a processed image, i.e. provide them with a color code (0, 0, 0), in which no objects were detected. According to the invention, an orthogonal top view of a rearward road section, in which the two-wheeled vehicle moves, is continuously calculated.

Expediently, the processing unit is arranged for using a correction matrix upon transformation of the processed image using homography, which is provided for correction of a slanting horizon line, which in particular occurs with an inclination of the two-wheeled vehicle by the roll angle and/or the pitch angle, wherein, for each roll and pitch angle, a correction matrix associated with the roll and pitch angle, determined by an inertial measurement unit at the time of an image being captured, is deposited in the processing unit. By referring to a uniform view, i.e. a view with a horizontal horizon line, a higher accuracy when capturing objects can be effected. Faulty capturing, caused by the roll and/or pitch angle, may be advantageously avoided.

In a further embodiment of the invention, an analysis unit is provided, which is arranged for, preferably continuously, determining a distance of at least one vehicle to the two-wheeled vehicle and/or a speed of the at least one vehicle, wherein the distance, in particular in a depiction showing an orthogonal top view of a rearward road section, is determined by calculating a distance of the two-wheeled vehicle from a contact point. The analysis unit determines a distance of a captured vehicle from the motorcycle for each depiction showing an orthogonal top view by determining their distance in pixels and converting it into a distance in meters. The contact point is that point, at which, upon capturing an object in the rearward space, there is a transition of the vehicle to a road surface. If, for example, a digital image of the rear space with a motor vehicle is created, then the contact point is located at the transition of a color of the vehicle to a color of a road surface. Thereby a distance of the vehicle to the two-wheeled vehicle may be determined in the analysis in a particularly accurate fashion.

Expediently, an analysis unit is provided, which is arranged for determining a time-to-collision. Advantageously, it can be estimated, when a possible collision is imminent upon changing lanes. Thereby, a warning corresponding to a hazardous situation can be indicated to the two-wheeled vehicle driver.

In one embodiment of the invention, a unit is provided, which is arranged for controlling a preferably acoustic, optical and/or haptic warning signal means. The activation is triggered by a signal, which an analysis unit generates, which is arranged for determining a distance of a vehicle from the two-wheeled vehicle and/or for determining a time-to-collision. Advantageously, a two-wheeled vehicle driver can be warned in time, when a risk of collision is imminent. For that, several warning stages are conceivable, the activation of which depends on an estimated time-to-collision.

In a further embodiment of the invention, the optical warning means comprises a warning light, for which a color and/or a flashing frequency is or are, resp., changeable, and the haptic or acoustic signal means comprises at least one vibration element, which is in particular integrated into handlebar grips of the two-wheeled vehicle, into a piece of clothing of the two-wheeled vehicle driver, in particular into a glove, into a helmet of the two-wheeled vehicle driver, and/or into a seat of the two-wheeled vehicle. Depending on the distance of a vehicle from the two-wheeled vehicle, differently strong warnings can be displayed to a two-wheeled vehicle driver. While at a relatively long distance of 50 m, for example, and a long time-to-collision, a warning light in a dashboard could flash, at a shorter distance of less than 30 m and a shorter time-to-collision, a vibration, better perceptible by the driver, should be triggered. A combination of an optical signal with a haptic signal, for example red flashing or permanently red illumination of the warning light as well as a permanent or pulsating vibration of the handlebar grips, would also be conceivable. Furthermore, in particular the optical warning signal could be displayed on the inside of a helmet visor of the two-wheeled vehicle driver and/or in a so-called head-down display of the two-wheeled vehicle.

In one embodiment of the invention, an actuator controllable by the controlling unit is provided, which is preferably integrated into a steering head of the motorcycle, and which may effect a change in direction of a front wheel of the two-wheeled vehicle, opposing the steering movement of the two-wheeled vehicle driver, wherein an angle change effected by the actuator is between 1 and 20 degrees. With the change in direction of the front wheel, a last warning stage can be triggered, since a so-called righting moment is generated, which warns the two-wheeled vehicle driver of a collision by minimal righting of the two-wheeled vehicle. Furthermore, the controlling unit can control the actuator such that a lane change is aborted and the two-wheeled vehicle returns to its original lane. It is understood, that the driver can bypass or override the warning signals as well as the steering intervention any time.

Expediently, the sensor device, in particular the at least two sensors, is/are integrated into a seat of a motorcycle or bicycle or attached to a seat, to a chain stay of a bicycle, to a swing arm of a motorcycle or, above a license plate, to a license plate holder.

In one embodiment of the invention, the sensor device is arranged for capturing the different ranges of the rearward space distinct from one another, so that no overlaps of the ranges occur. The sensor device can be arranged at the two-wheeled vehicle such that each sensor captures a certain range and is blind for another range. Advantageously, analysis of the sensor signals, in particular processing of digital images, is simplified.

In the following, the invention is discussed in more detail on the basis of embodiments and the appended drawings referring to the embodiments. Therein:

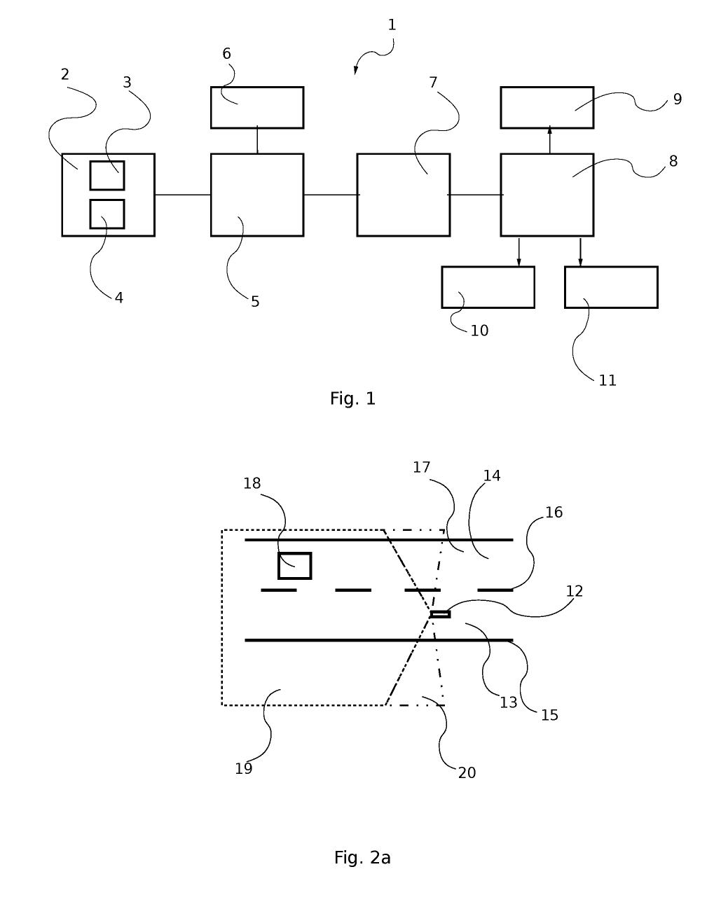

FIG. 1 is a schematic representation of an apparatus according to the invention,

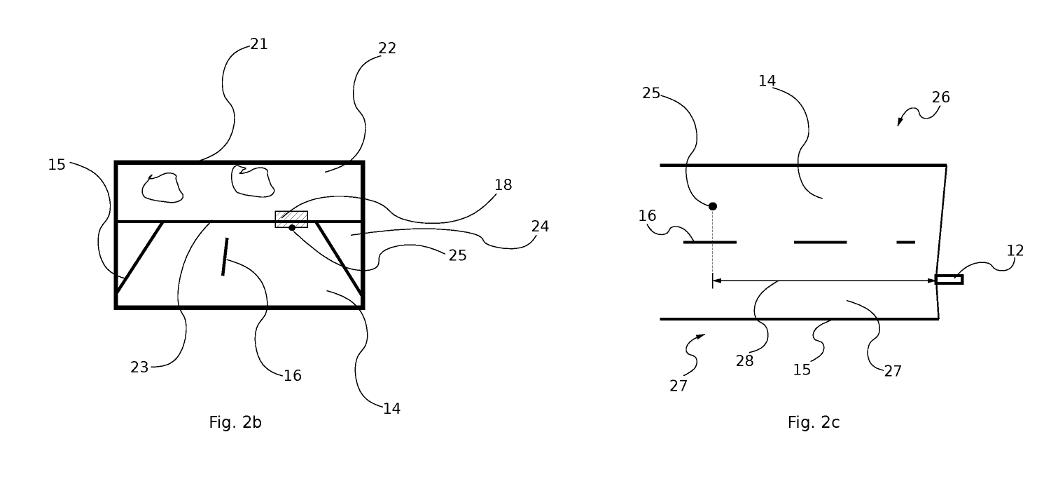

FIG. 2a is a top view of a two-lane, straight road with a rearward space monitored by the apparatus according to the invention,

FIG. 2b is a schematic representation of an image of the rearward space determined by an image processing unit upon driving on a straight road,

FIG. 2c is a calculated, orthogonal top view of a rearward road section shown in FIG. 2a,

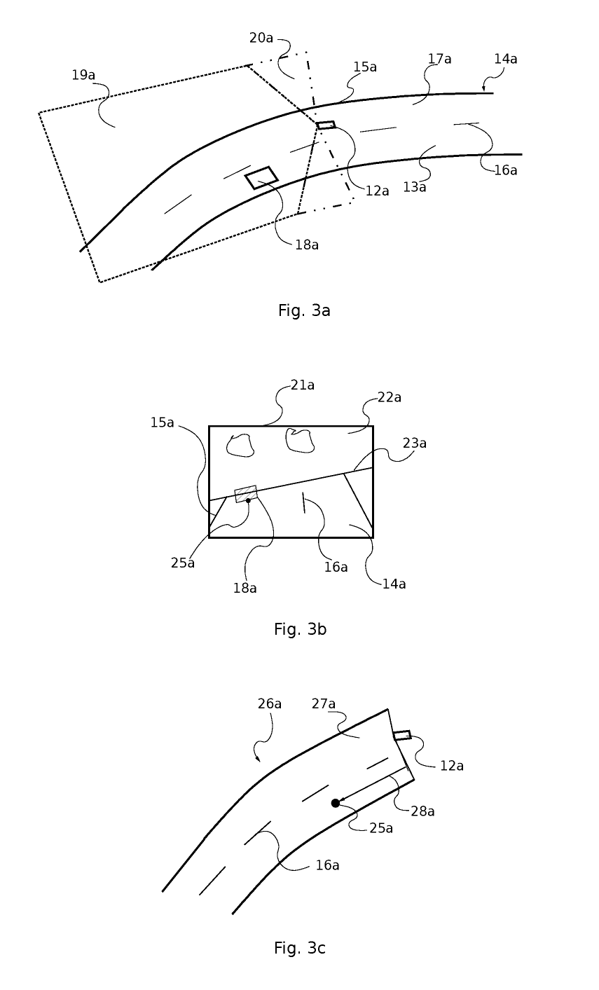

FIG. 3a is a top view of a bend of a two-lane road with a rearward space monitored by the apparatus according to the invention,

FIG. 3b is a schematic representation of an image of the rearward space determined by an image processing unit upon taking a bend,

FIG. 3c is a calculated, orthogonal top view of a rearward road section shown in FIG. 3a.

A schematic representation of an apparatus (1) according to the invention shown in FIG. 1, which is attached to a motorcycle, comprises a sensor device (2) having a mono-camera (3) and a camera with a fisheye lens (4) with digital image sensors, as well as an image processing unit (5), which comprises a computer for digital image processing and which can process the images captured by the cameras (3, 4) in real-time as well as detect lane boundaries, road markings, vehicles and centerlines of a road surface. In that, the image processing unit (5) is arranged to either create a single image from respectively one image of the mono-camera (3) and one image of the camera (4) with the fisheye lens by determining an overlap area, i.e. an area visible in both images, or two new images from these two images, of which one shows a far range and one shows a close range, wherein the overlap area is allocated to the image of the far range. Information on a pitch angle or a roll angle, by which the motorcycle is inclined towards a road surface upon taking a bend, can be determined by an inertial measurement unit (6), which is formed as a rotation rate sensor. An analysis unit (7) is arranged for determining, based on the processed images of the image processing unit (5), a distance of a vehicle approaching the motorcycle from behind and its absolute as well as relative speed to the motorcycle, in order to determine a time-to-collision. A unit (8) for controlling an actuator (9) is provided to control an actuator (9) integrated into a steering head of a motorcycle, so that, in a hazardous situation, a change in direction of a front wheel of the motorcycle (12) can be effected. Each activation of the actuator (9) is triggered by a signal of the analysis unit (7). Furthermore, a warning light (10), changeable in its color and its flashing frequency, as well as vibration elements (11) are provided, which can be controlled by the controlling unit (7).

A motorcycle (12) shown in FIG. 2a moves straight, i.e. in an upright position, in a right-hand lane (13) of a two-lane road (14), onto which lane boundary lines (15) as well as centerlines (16) are applied. In a left-hand lane (17), there is a further vehicle (18). A rearward space (19, 20), in which objects (15, 16, 18) are captured by a sensor device (2) of an apparatus (1) according to the invention, not shown in FIG. 2a, is divided into a far range (19) as well as a close range (20). The far range (19) is captured by a mono-camera (3) with a horizontal field of view (FoV) of 110 degrees, while the close range (20) is captured by a camera (4) with a fisheye lens and a horizontal field of view of 190 degrees. The far range (19) extends up to 50 m behind the motorcycle (12), while the close range (20) covers the blind spot. Thereby, vehicles (18) quickly approaching the motorcycle (12) from behind as well as vehicles located in the immediate vicinity of the motorcycle (12) can be captured by the sensor device (2).

FIG. 2b schematically shows an image (21), which a processing device (5) determines based on digital images of cameras (3, 4) of the sensor device (2) of the rearward space (19, 20) using known methods of digital image processing. An upper portion (22) of the image (21) is separated from a lower portion (24) of the image (21), in which the road surface (14), the lane boundary lines (15), the centerline (16) as well as another vehicle (18) are located, by a horizon line (23) running horizontally in FIG. 2b. In one point of the image, in which a transition of the vehicle (18) to the road surface (14) is located, there is a contact point (25) necessary for distance calculation between the vehicle (18) and the motorcycle (12).

Images continuously captured by the cameras (3, 4) are processed in real-time by the image processing unit (5), in order to reduce a computing effort when capturing objects, among other things, whereby the image (21) of the rearward space (19, 20) is created, in which, by means of a neural network, in particular a deep reinforcement algorithm, as well as the use of known hair-like features, objects (15, 16, 18) are detected. In that, when capturing objects, a contact point (25) is added to the vehicle (18). Using homography, there is a transformation into a depiction (26) shown in FIG. 2c, which shows an orthogonal top view of a rearward section (27) of the road (14). In the depiction (26), a distance of the vehicle (18) from the motorcycle (12) marked with an arrow (28) is determined by an analysis unit (7) based on a distance (28) of the motorcycle (12) from the contact point (25) with methods known to the skilled person.

Reference is now made to FIG. 3a, FIG. 3b, and FIG. 3c, wherein equal or similar parts are designated with the same reference number as in FIG. 1, FIG. 2a, FIG. 2b, and FIG. 2c, and the letter “a” is respectively added to the respective reference number.

A motorcycle (12a) shown in FIG. 3a differs from that shown in FIG. 2a by the fact that it is driving in a bend in a left-hand lane (17a) of a two-lane road (14a) and is inclined by a motorcyclist from an upright position by the so-called roll angle towards the road (14a) in a position for taking bends. Thereby, stable cornering is effected. In a right-hand lane (13a), there is a further vehicle (18a). For completion of a passing maneuver, a lane change to the right-hand lane (13a) is required.

An image (21a) shown in FIG. 3b differs from that shown in FIG. 2b by a horizon line (23a) being slanted by the roll angle of the motorcycle.

A depiction (26a) shown in FIG. 3c is a calculated, orthogonal top view of the scenario shown in FIG. 3a. The calculation of the depiction (26a) by a processing unit (5a) arranged for that is undertaken considering the roll and pitch angles of the motorcycle determined by an inertial measurement unit (6a). For that, respectively one correction matrix associated with the roll and pitch angles determined, which is deposited in the processing unit (5a), is used for performing homography. For each possible roll and pitch angle, a separate correction matrix is deposited, in order to correct an inclination of the horizon line (23a) when calculating the depiction (26a).

Due to the images (21; 21a) being continuously created upon movement of the motorcycle equipped with an apparatus (1) according to the invention, with a time difference between individual depictions (26; 26a) and the changing distance (28; 28a) of the contact point (25; 25a) to the motorcycle (12; 12a), the analysis unit (7; 7a) can determine an absolute as well as a relative speed of a vehicle (18; 18a) to the motorcycle (12; 12a) and therefrom calculate a time-to-collision. If a critical distance, at which a collision can be imminent, is reached, the controlling unit actuates a warning light (10) or a vibration element (11). Different warning stages can, for example, be displayed by different colors of the warning light. If the vehicle (18; 18a) is located in the far range (19; 19a), with a sufficiently long time-to-collision, the light could illuminate yellow, and with a short time-to-collision, it could illuminate red. If however, it is already located in the close range (20; 20a), it could illuminate flashing red. Conceivable would also be a possibly additional haptic warning signal, for example triggered by actuating an indicator, preferably a pulsating or permanent vibration of the vibration elements (11), which may be integrated into a seat of the motorcycle, into a helmet of the driver and/or into a glove of the driver.

Furthermore, a further warning stage, signalizing the highest risk of collision, can be issued by the controlling unit (8). If, for example, despite a warning of a vehicle (18; 18a) located in the close range (20; 20a) or of a vehicle (18; 18a) in the far range (19, 19a) at a short time-to-collision, the driver initiates a lane change, the controlling unit (9) is further provided to control the actuator (9) attached in the steering head of the motorcycle such that a change in direction of the front wheel, opposing a steering movement of the driver or a rolling movement of the motorcycle (12; 12a) in the direction of a road (14; 14a), is effected. This intervention results in a righting moment, effecting a minimal righting of the motorcycle (12; 12a), which is perceptible for the driver. This is perceived as the last warning before collision.

The sensor device (2; 2a) may be fixed to or at a rear of a motorcycle (12; 12a), for example at a seat or a license plate holder. A warning light (10; 10a) is installed in a dashboard, not shown, of the motorcycle (12; 12a) or is located at another position, at which it is noticeable for a motorcyclist, for example on an inside of a visor of the motorcycle helmet. The vibration elements (11) may be integrated into handlebar grips, into a seat or a piece of clothing of the motorcyclist, for example in gloves.

It is understood that the distances of the vehicle (18; 18a) from the motorcycle (12; 12a), at which a warning (10, 11; 10a, 11a) is triggered, are not consistent, but depend on the speed. The faster a vehicle (18; 18a) approaches the motorcycle (12; 12a), the earlier the warning (10, 11; 10a, 11a) is issued.

Furthermore, the warnings (10, 11; 10a, 11a) signaled may be ignored and overridden by the driver.

It is also conceivable that a far range (19; 19a) and a close range (20; 20a) are captured by a sensor device (2) such that they are distinct from one another and do not overlap. Thereby, a computing effort upon determining an image (21; 21a) can be reduced.

Furthermore, it is conceivable that a depiction (26; 26a) showing the orthogonal top view of a road section of the rearward space is displayed on a display.

1. An apparatus for warning a two-wheeled vehicle driver, in particular a motorcyclist or cyclist, of a collision with a vehicle approaching the two-wheeled vehicle from a rearward space, comprising a sensor device for capturing objects in the rearward space, characterized in that the sensor device has at least two sensors arranged for capturing objects in different areas of the rearward space.

2. The apparatus according to claim 1, characterized in that at least two structurally identical sensors or sensors different from one another are provided, which are in particular arranged for capturing road markings, lane boundaries and/or a vehicle approaching the two-wheeled vehicle.

3. The apparatus according to claim 1, characterized in that one of the sensors is provided for capturing objects in a close rearward range, which, in particular for the two-wheeled vehicle driver, is in the blind spot, and a further one of the sensors is arranged for capturing objects in a far rearward range, which in particular extends up to 50 m away from the two-wheeled vehicle.

4. The apparatus according to claim 1, characterized in that at least one of the sensors, preferably two of the sensors, is or are, resp., formed as a digital camera, and a first sensor is in particular formed as a mono-camera and a second sensor is in particular formed as a camera with a wide-angle and/or fisheye lens, wherein the mono-camera further has a horizontal and/or vertical field of view of at least 90 degrees, preferably 110 degrees, and the camera with the wide-angle and/or fisheye lens has a horizontal and/or vertical field of view of at least 170 degrees, preferably 190 degrees.

5. The apparatus according to claim 1, characterized in that the mono-camera is provided for capturing objects in the far rearward range, in particular up to a depth of at least 30 m, preferably at least 40 m, particularly preferred 50 m, behind the two-wheeled vehicle, and the camera with the wide-angle and/or fisheye lens is arranged for capturing objects in the close rearward range.

6. The apparatus according to claim 1, characterized in that at least one inertial measurement unit, in particular a rotation rate sensor, is provided, which, preferably continuously, determines a roll angle and/or a pitch angle of the two-wheeled vehicle.

7. The apparatus according to claim 4, characterized in that an image processing unit is arranged for creating a single image from two images of the cameras taken at a same point in time by determining an overlap area, or for creating an image of the close range as well as an image of the far range from two images of the cameras taken at a same point in time, wherein an overlap area is at least partially allocated to the image of the far range.

8. The apparatus according to claim 1, characterized in that a unit for processing sensor signals is provided, which is in particular arranged for real-time processing of digital images, wherein in upper and in lower portions of images of the rearward space, objects, in particular road markings, lane boundaries and/or vehicles behind the two-wheeled vehicle, are detected above and below a horizon line, and a transformation of the processed image is undertaken using homography in a depiction showing an orthogonal top view of a rearward road section.

9. The apparatus according to claim 7, characterized in that the processing unit, upon transformation of the processed image using homography, is arranged for using a correction matrix, which is provided for correcting a slanting horizon line, which in particular occurs with an inclination of the two-wheeled vehicle by the roll angle and/or the pitch angle, wherein, for each roll and pitch angle, a correction matrix associated with the roll and pitch angle, determined by an inertial measurement unit at the point in time of an image being captured, is deposited in the processing unit.

10. The apparatus according to claim 1, characterized in that an analysis unit (7) is provided, which is arranged for, preferably continuously, determining a distance from at least one vehicle to the two-wheeled vehicle and/or a speed of the at least one vehicle, wherein the distance is in particular determined in a depiction, showing an orthogonal top view of a rearward road section by calculating a distance of the two-wheeled vehicle from a contact point.

11. The apparatus according to claim 1, characterized in that an analysis unit is provided, which is arranged for determining a time-to-collision.

12. The apparatus according to claim 1, characterized in that a unit is provided, which is arranged for controlling a preferably acoustic, optical and/or haptic warning signal means.

13. The apparatus according to claim 12, characterized in that the optical warning signal means comprises a warning light, for which a color and/or a flashing frequency is or are, resp., changeable, and the haptic or acoustic signal means comprises at least one vibration element, which is in particular integrated into handlebar grips of the two-wheeled vehicle, into a piece of clothing of the two-wheeled vehicle driver, in particular into a glove, into a helmet of the two-wheeled vehicle driver, and/or into a seat of the two-wheeled vehicle.

14. The apparatus according to claim 12, characterized in that an actuator (9) controllable by the control unit is provided, which is preferably integrated into a steering head of the two-wheeled vehicle, and which may effect a change in direction of a front wheel of the two-wheeled vehicle, opposing a steering movement of the two-wheeled vehicle driver, wherein an angle change effected by the actuator is between 1 and 20 degrees.

15. The apparatus according to claim 1, characterized in that the sensor device, in particular the at least two sensors, is integrated into a seat of a motorcycle or bicycle or attached to a seat, to a chain stay of a bicycle, to a swing arm of a motorcycle or, above a license plate, to a license plate holder.

16. The apparatus according to claim 1, characterized in that the sensor device is arranged for capturing the different ranges of the rearward space distinct from one another, so that no overlaps of the ranges occur.
